(19) United States
(12) Patent Application Publication
(10) Pub. No.: US 2018/0089907 A1
(43) Pub. Date: Mar. 29, 2018

(54) PERIPHERY MONITORING DEVICE

(71) Applicant: AISIN SEIKI KABUSHIKI KAISHA, Kariya-shi (JP)

(72) Inventors: Tetsuya MARUOKA, Okazaki-shi (JP); Kazuya WATANABE, Anjo-shi (JP); Yoji INUI, Ama-gun (JP); Kinji YAMAMOTO, Anjo-shi (JP); Takashi HIRAMAKI, Nagoya-shi (JP); Takuya HASHIKAWA, Nagoya-shi (JP); Naotaka KUBOTA, Kariya-shi (JP); Osamu KIMURA, Nagoya-shi (JP); Itsuko OHASHI, Nagoya-shi (JP)

(73) Assignee: AISIN SEIKI KABUSHIKI KAISHA, Kariya-shi (JP)

(21) Appl. No.: 15/611,965

(22) Filed: Jun. 2, 2017

(30) Foreign Application Priority Data
Sep. 29, 2016 (JP) 2016-190659

(51) Int. Cl. G06T 19/20; B60R 1/12; B60K 35/00; G06T 19/00; H04N 7/18; G06K 9/00; G06K 9/78

(52) U.S. Cl. CPC G06T 19/20; G06T 2219/2012; B60K 35/00; G06T 19/006; H04N 7/181; G06K 9/00805; G06K 9/00201; G06K 9/78; B60R 2001/1253; B60R 2300/105; B60R 2300/301; B60R 2300/8066; B60K 2350/352; B60K 2350/106; B60K 2350/1028; B60K 2350/2013; G06T 2219/2004; B60R 1/12

(57) ABSTRACT

A periphery monitoring device includes: an acquisition unit that acquires an image indicating a peripheral environment of a vehicle and information corresponding to a state of the vehicle, the image being captured by an imaging device that is provided in the vehicle; a memory that stores a vehicle model that indicates a three-dimensional shape of the vehicle; a processing unit that processes the vehicle model based on the information; and an output unit that superimposes the vehicle model processed by the processing unit on a position within the image indicating the peripheral environment corresponding to a position within the peripheral environment where the vehicle is present, and displays the image indicating the peripheral environment and having the vehicle model superimposed thereon on a display screen that is provided in a vehicle compartment of the vehicle.

### CROSS REFERENCE TO RELATED APPLICATIONS

This application is based on and claims priority under 35 U.S.C. § 119 to Japanese Patent Application 2016-190659, filed on Sep. 29, 2016, the entire contents of which are incorporated herein by reference.

### TECHNICAL FIELD

This disclosure relates to a vehicle periphery monitoring device.

### BACKGROUND DISCUSSION

In the related art, there has been a technology of capturing an image of a peripheral environment of a vehicle using a camera provided in the vehicle, and providing the captured image to a driver through a display screen provided in a vehicle compartment of the vehicle. See, e.g., JP 2016-021653A (Reference 1).

For example, a driver may want to objectively check the vehicle state while staying in the vehicle compartment. In this respect, the above described technology has room for improvement.

Thus, a need exists for a periphery monitoring device which is not susceptible to the drawback mentioned above.

### SUMMARY

A periphery monitoring device according to an aspect of this disclosure includes, for example, an acquisition unit that acquires an image indicating a peripheral environment of a vehicle and information corresponding to a state of the vehicle, in which the image is captured by an imaging device that is provided in the vehicle; a memory that stores a vehicle model that indicates a three-dimensional shape of the vehicle; a processing unit that processes the vehicle model based on the information; and an output unit that superimposes the vehicle model processed by the processing unit on a position within the image indicating the peripheral environment corresponding to a position within the peripheral environment where the vehicle is present, and displays the image indicating the peripheral environment and having the vehicle model superimposed thereon on a display screen that is provided in a vehicle compartment of the vehicle. The periphery monitoring device reflects the state of the vehicle on the image of the vehicle displayed on the display screen in real time, and thus may display the state of the vehicle in an objectively and easily understandable manner.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an exemplary vehicle mounted with a periphery monitoring device according to a first embodiment, through which a vehicle compartment is partially viewed;

FIG. 2 is a plan view (overhead view) illustrating the exemplary vehicle mounted with the periphery monitoring device according to the first embodiment;

FIG. 3 is a view illustrating an exemplary dashboard of the vehicle mounted with the periphery monitoring device according to the first embodiment, when viewed from the rear side of the vehicle;

FIG. 4 is a block diagram illustrating an exemplary configuration of a periphery monitoring system according to the first embodiment;

FIG. 5 is a view illustrating a display example of a display screen according to the first embodiment;

FIG. 6 is a view illustrating another display example of a display screen according to the first embodiment;

FIG. 7 is a view illustrating another display example of a display screen according to the first embodiment;

FIG. 8 is a view illustrating another display example of a display screen according to the first embodiment;

FIG. 9 is a block diagram illustrating a functional configuration of an ECU as the periphery monitoring device according to the first embodiment;

FIG. 10 is a view illustrating the structure of a ring buffer in the first embodiment;

FIG. 11 is a flow chart illustrating an image storage processing procedure in the periphery monitoring device according to the first embodiment;

FIG. 12 is a flow chart illustrating a display control processing procedure in the periphery monitoring device according to the first embodiment;

FIG. 13 is a block diagram illustrating a functional configuration of an ECU as the periphery monitoring device according to a second embodiment;

FIG. 14 is a view illustrating a display example of a display screen according to the second embodiment; and

FIG. 15 is a view illustrating another display example of a display screen according to the second embodiment.

### DETAILED DESCRIPTION

Hereinafter, descriptions will be made on an example of a periphery monitoring device according to the embodiment, which is mounted in a vehicle 1.

### First Embodiment

The vehicle 1 according to the first embodiment may be, for example, an automobile using an internal combustion engine (not illustrated) as a drive source, that is an internal combustion engine automobile, or an automobile using an electric motor (not illustrated) as a drive source, that is, an electric automobile, a fuel cell automobile, or the like. Alternatively, the vehicle 1 may be a hybrid automobile using both of them as a drive source, or an automobile provided with another driving source. The vehicle 1 may be mounted with various transmission devices, or various devices (e.g., systems and components) required for driving an internal combustion engine or an electric motor. The types, the number, the layout, or the like of devices related to driving of a wheel 3 in the vehicle 1 may be variously set.

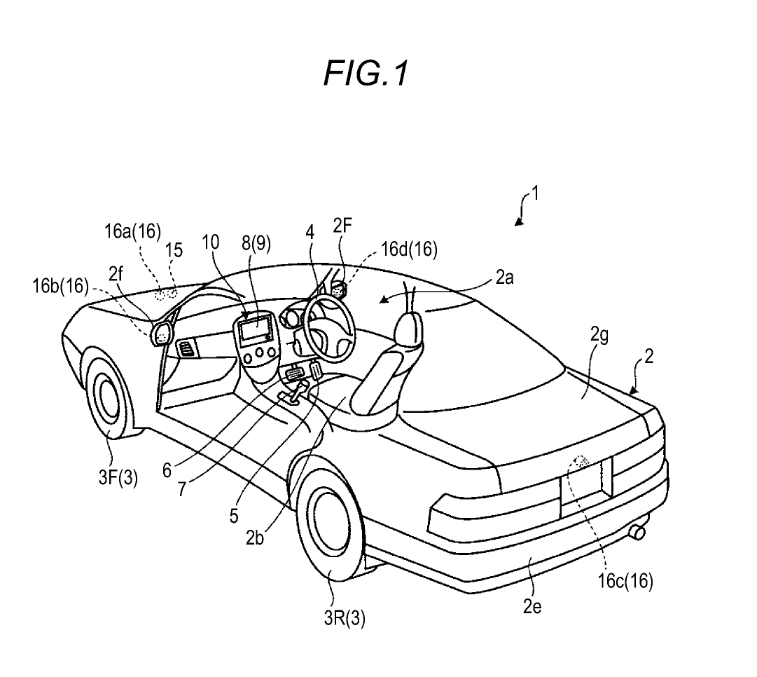

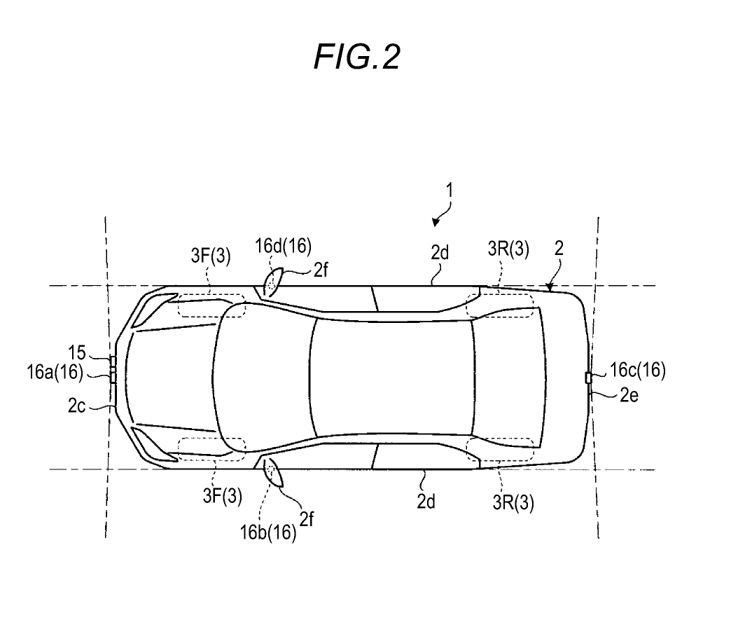

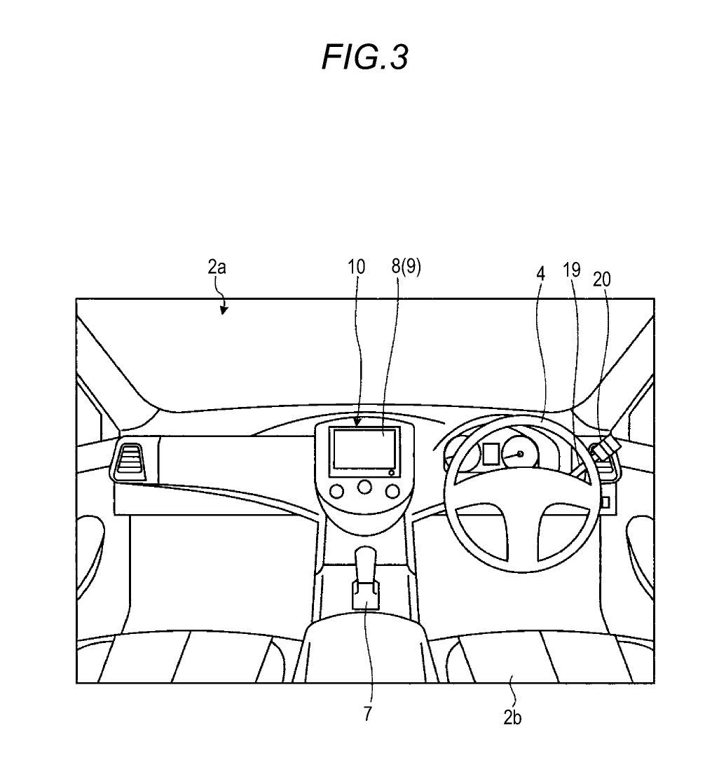

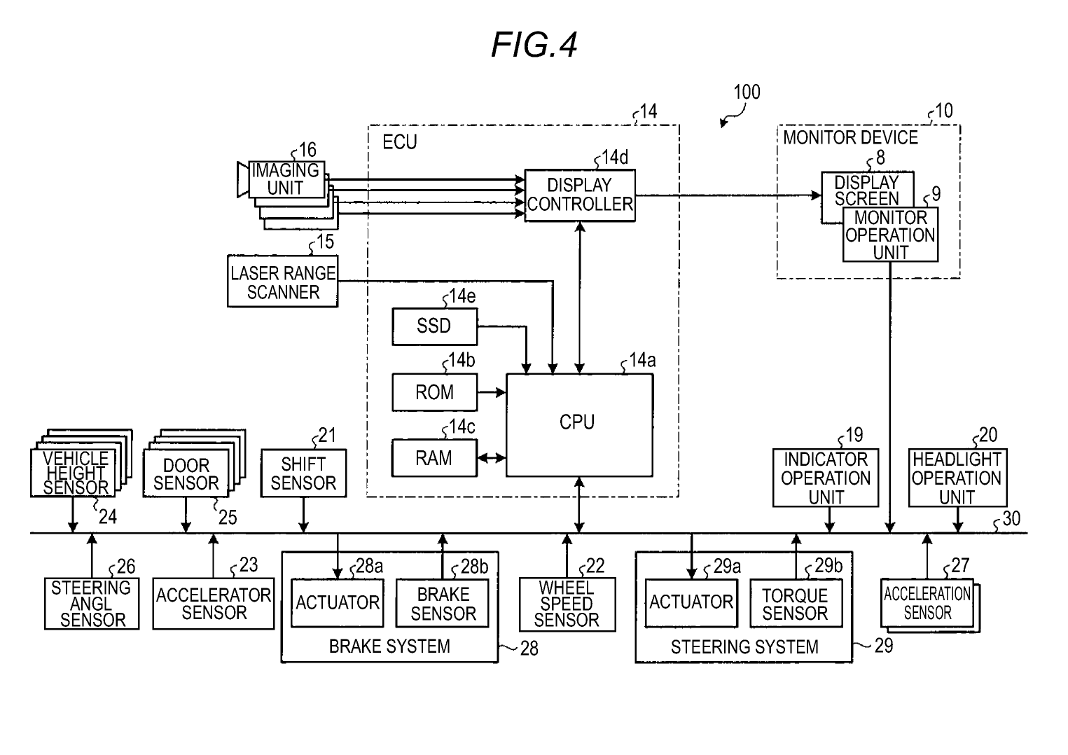

FIG. 1 is a perspective view illustrating an exemplary vehicle 1 mounted with a periphery monitoring device according to a first embodiment, through which a part of a vehicle compartment 2a is seen. FIG. 2 is a plan view (overhead view) illustrating the exemplary vehicle 1 mounted with the periphery monitoring device according to the first embodiment. FIG. 3 is a view illustrating an exemplary dashboard of the vehicle 1 mounted with the periphery monitoring device according to the first embodiment, and is a view from behind the vehicle 1. FIG. 4 is a block diagram illustrating an exemplary configuration of a periphery monitoring system 100 including the periphery monitoring device according to the first embodiment.

As illustrated in FIG. 1, a vehicle body 2 constitutes the vehicle compartment 2a on which a user (not illustrated) gets. Within the vehicle compartment 2a, a steering unit 4, an accelerating unit 5, a braking unit 6, a gear shift unit 7, and the like are provided in a state of facing a seat 2b of a driver as a user. The steering unit 4 is, for example, a steering wheel protruding from the dashboard, the accelerating unit 5 is, for example, an accelerator pedal disposed under the feet of the driver, the braking unit 6 is, for example, a brake pedal disposed under the feet of the driver, and the gear shift unit 7 is, for example, a shift lever protruding from a center console. The steering unit 4, the accelerating unit 5, the braking unit 6, and the gear shift unit 7 are not limited to these.

As illustrated in FIGS. 1 and 3, a monitor device 10 including a display screen 8 is provided within the vehicle compartment 2a. The display screen 8 is constituted by, for example, a liquid crystal display (LCD), an organic electroluminescent display (OELD), or the like. The display screen 8 is covered with a transparent monitor operation unit 9. The monitor operation unit 9 is, for example, a touch panel. The user may visually recognize an image displayed on the display screen 8 through the monitor operation unit 9. The user may perform an operation of touching, pressing, or moving on the monitor operation unit 9 with a finger or the like at a position corresponding to the image displayed on the display screen 8 so as to execute an operation input. The monitor device 10 is provided at, for example, the center portion in the vehicle width direction (that is, left-right direction) of the dashboard. The monitor device 10 may include a monitor operation unit in addition to the touch panel. For example, the monitor device 10 may include a switch, a dial, a joystick, or a push button as another monitor operation unit. The monitor device 10 may also be used as, for example, a navigation system or an audio system.

Within the vehicle compartment 2a, an indicator operation unit 19 which is a lever for accepting an operation of causing a direction indicator to display a direction indication is provided at the right side of a steering column supporting the steering unit 4. The user may cause the direction indicator to display a desired course by vertically pushing down or pushing up the indicator operation unit 19. The indication of the course is expressed by blinking of the direction indicator in the traveling direction. A headlight operation unit 20 which is a dial for accepting an operation of turning ON or OFF a headlight is disposed at the tip end of the indicator operation unit 19. The user may turn ON or OFF the headlight by rotating the headlight operation unit 20. Like the monitor operation unit 9, various operation units 19 and 20 are not limited thereto. The locations where the various operation units 19 and 20 are disposed and operation methods of the operations units 19 and 20 may be arbitrarily changed.

As illustrated in FIGS. 1 and 2, in the first embodiment, for example, the vehicle 1 is a four-wheeled vehicle, and includes two left/right front wheels 3F, and two left/right rear wheels 3R. For example, the tire angles of the front wheels 3F are changed according to the operation of the steering unit 4.

In the first embodiment, as illustrated in FIG. 2, a laser range scanner 15 and imaging units 16 (here, four imaging units 16a to 16d) are provided. Each of the imaging units 16 is, for example, an imaging device incorporating an imaging element such as, a charge coupled device (CCD) or a CMOS image sensor (CIS). Each of the imaging units 16 may capture an image indicating the peripheral environment by the imaging element. The imaging unit 16 may execute image capturing and output of a captured image at a predetermined frame rate.

In the first embodiment, the imaging unit 16a is disposed on a front end portion (e.g., a front grille 2c) of the vehicle body 2. The imaging unit 16a may image the peripheral environment in the forward direction of the vehicle 1. Meanwhile, a direction in which the driver seated in the seat 2b faces the front, that is, a front glass side viewed from the driver, is considered as the front side of the vehicle 1 and the front side of the vehicle body 2. The imaging unit 16b is provided on a left door mirror 2f. The imaging unit 16b may image the peripheral environment in the left direction of the vehicle 1. The imaging unit 16c is provided on a lower wall portion of a door 2g of a rear trunk. The imaging unit 16c may be provided on a rear bumper 2e. The imaging unit 16c may image the peripheral environment in the rearward direction of the vehicle 1. The imaging unit 16d is provided on a right door mirror 2f. The imaging unit 16d may image the peripheral environment in the right direction of the vehicle 1.

The peripheral environment refers to a situation around the vehicle 1. For example, the peripheral environment includes a road surface around the vehicle 1. As long as each of the imaging units 16 may output an image on which the peripheral environment of the vehicle 1 is captured, the configurations, the number, the installation locations, and the directions of the imaging units 16 are not limited to the above described contents. The ranges in which the plural imaging units 16 may capture images may or may not overlap.

The laser range scanner 15 is an example of a measuring unit for measuring a three-dimensional shape of a road surface. The laser range scanner 15 is provided, for example, in the vicinity of the imaging unit 16a on the front grille 2c. The laser range scanner 15 measures the three-dimensional shape of a road surface (here, a road surface in the forward direction of the vehicle 1). The laser range scanner 15 includes a light source (a laser diode, etc.) and a light receiving element therein. The light source three-dimensionally emits a laser beam to a region that covers the road surface in the forward direction of the vehicle 1. When an object present in the corresponding region is irradiated with the laser beam, the laser beam is reflected. The reflected laser beam (reflected waves) is received by the light receiving element. Information of the light receiving element is sent to an electronic control unit (ECU) 14, and the ECU 14 may obtain topographical data indicating the road surface three-dimensional shape by evaluating the information sent from the light receiving element, and performing computation. In one example, the laser range scanner 15 generates point group data indicating distances and directions of respective positions reflecting the laser beam, in the region irradiated with the laser beam. The laser range scanner 15 transmits the generated point group data to the ECU 14. The data output by the laser range scanner 15 is not limited to the point group data. The laser range scanner 15 is configured to output topographical data.

As long as the road surface three-dimensional shape in the traveling direction of the vehicle 1 may be measured, the configuration, the installation location, and the direction of the laser range scanner 15, and the number of laser range scanners 15 are not limited to the above described contents. As a measuring unit for measuring the three-dimensional shape of the road surface, any device may be employed in place of the laser range scanner 15. For example, a stereo camera may be employed as the measuring unit.

As illustrated in FIG. 4, in the periphery monitoring system 100, the monitor device 10, the ECU 14, the indicator operation unit 19, the headlight operation unit 20, a shift sensor 21, a wheel speed sensor 22, an accelerator sensor 23, four vehicle height sensors 24, four door sensors 25, a steering angle sensor 26, two acceleration sensors 27, a brake system 28, and a steering system 29 are electrically connected to each other via an in-vehicle network 30. The in-vehicle network 30 is configured as, for example, a controller area network (CAN). The ECU 14 may control the brake system 28 and the like by sending control signals through the in-vehicle network 30, and may receive detection information from the shift sensor 21, the wheel speed sensor 22, the accelerator sensor 23, the vehicle height sensors 24, the door sensors 25, the steering angle sensor 26, the acceleration sensors 27, a brake sensor 28b, a torque sensor 29b and the like, and operation information from the monitor operation unit 9, the indicator operation unit 19, the headlight operation unit 20, and the like through the in-vehicle network 30. The ECU 14 may receive point group data from the laser range scanner 15 and images from the imaging units 16a to 16d.

The steering system 29 is configured to steer at least two wheels 3. The steering system 29 includes an actuator 29a and the torque sensor 29b. The steering system 29 is electrically controlled by the ECU 14 or the like to operate the actuator 29a. The steering system 29 is, for example, an electric power steering system, a steer by wire (SBW) system or the like. The steering system 29 may be a rear wheel steering system (active rear steering (ARS)). The actuator 29a may steer one wheel 3, or may steer plural wheels 3. The torque sensor 29b detects, for example, a torque which the driver applies to the steering unit 4.

The shift sensor 21 detects, for example, the position of a movable portion of the gear shift unit 7.

The wheel speed sensor 22 detects the rotation amount of the wheel 3 or the number of revolutions of the wheel 3 per unit time.

The accelerator sensor 23 detects, for example, the position of an accelerator pedal as a movable portion of the accelerating unit 5.

The four door sensors 25 are disposed at different doors 2d, respectively. Each of the door sensors 25 detects at least whether the corresponding door 2d is opened or closed. Each door sensor 25 may detect the angle at which the door 2d is opened. When the number of the doors 2d provided in the vehicle 1 is not four, the number of the door sensors 25 is not limited to four. The door sensors 25 may not be provided in all the doors 2d. The door sensor 25 may be provided in the rear trunk door 2g.

The steering angle sensor 26 detects, for example, the steering amount of the steering unit 4 such as a steering wheel. The steering angle sensor 26 detects the steering angle information such as a steering amount of the steering unit 4 steered by the driver, and a steering amount of each wheel 3 during automatic steering.

The two acceleration sensors 27 detect an acceleration used for calculating a pitch angle and a roll angle. One of the two acceleration sensors 27 detects an acceleration in the left-right direction of the vehicle 1. The other of the two acceleration sensors 27 detects an acceleration in the front-rear direction of the vehicle 1.

The brake system 28 includes an actuator 28a and a brake sensor 28b. The brake system 28 applies a braking force to the wheels 3 through the actuator 28a. The brake sensor 28b detects, for example, the position of a brake pedal as a movable portion of the braking unit 6.

The four vehicle height sensors 24 are disposed at different suspensions (not illustrated), respectively. The suspensions are extensible, and perform at least positioning of the corresponding wheels 3. While extending and contracting, the suspensions may buffer the impact from the road surface. Each of the vehicle height sensors 24 detects the extension/contraction amount of a corresponding suspension.

The ECU 14 is, for example, a computer. The ECU 14 includes a central processing unit (CPU) 14a, a read only memory (ROM) 14b, a random access memory (RAM) 14c, a display controller 14d, and a solid state drive (SSD) 14e. The CPU 14a, the ROM 14b, and the RAM 14c may be integrated in the same package.

The CPU 14a reads a program stored in a non-volatile memory device such as the ROM 14b and executes various arithmetic processings and controls according to the program. The CPU 14a executes, for example, an imaging processing or the like related to an image to be displayed on the display screen 8.

The ROM 14b stores programs, and parameters and the like required for executing the programs. The RAM 14c temporarily stores various data used for calculation in the CPU 14a. The display controller 14d mainly executes a processing of a captured image acquired by the imaging unit 16 and output to the CPU 14a, a data conversion of a display image acquired from the CPU 14a and displayed on the display screen 8, and the like among arithmetic processings in the ECU 14. The SSD 14e is a rewritable non-volatile memory unit, and may store data acquired from the CPU 14a even when the ECU 14 is powered OFF.

Here, the ECU 14 is an example of a periphery monitoring device. Main characteristics of the periphery monitoring device according to the first embodiment will be described.

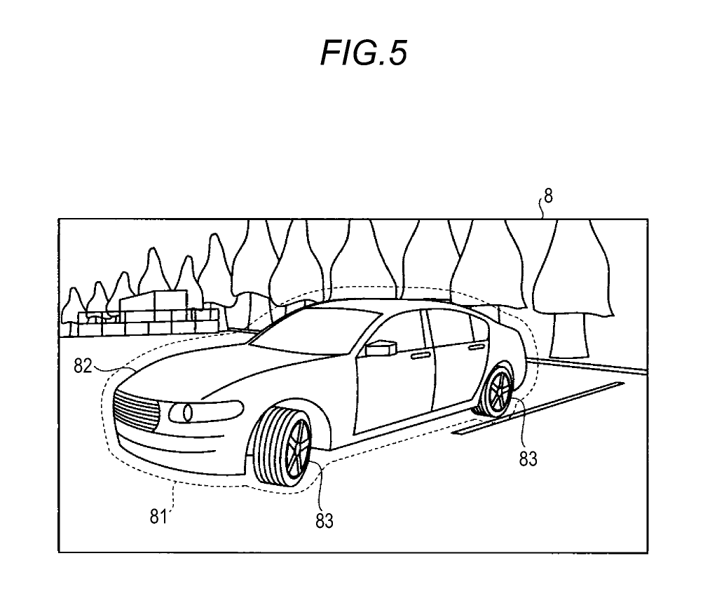

FIG. 5 is a view illustrating a display example of the display screen 8 according to the first embodiment. As illustrated in the drawing, the periphery monitoring device displays an image indicating a peripheral environment on the display screen 8, and displays and superimposes an image 81 indicating the external appearance of the vehicle 1 (hereinafter, referred to as “vehicle model image 81”) on the image indicating the peripheral environment. The periphery monitoring device stores a vehicle model (vehicle model 211) indicating the three-dimensional shape of the vehicle 1 in advance. The periphery monitoring device disposes the vehicle model 211 and a virtual viewpoint in a virtual space, calculates an image visible when the vehicle model 211 is viewed from the virtual viewpoint, and sets the obtained image as the vehicle model image 81. That is, the vehicle model image 81 is an example of the vehicle model 211 that is displayed. The relationship between the vehicle model image 81 and the image indicating the peripheral environment corresponds to the actual relationship between the vehicle 1 and the peripheral environment. That is, the periphery monitoring device superimposes the vehicle model 211 on the position within the image indicating the peripheral environment corresponding to the position of the peripheral environment where the vehicle 1 is present so that an image indicating the peripheral environment on which the vehicle model 211 is superimposed is displayed on the display screen 8.

Here, the periphery monitoring device acquires the state of the vehicle 1, and reflects the acquired state on the vehicle model 211, thereby reflecting the state of the vehicle 1 on the vehicle model image 81. The state of the vehicle 1 includes the external aspects of the parts or settings of the vehicle 1. The periphery monitoring device determines the state of the vehicle 1 based on information corresponding to the state of the vehicle 1. The information corresponding to the state of the vehicle 1 includes detection results of various sensors or operation information input to various operation units.

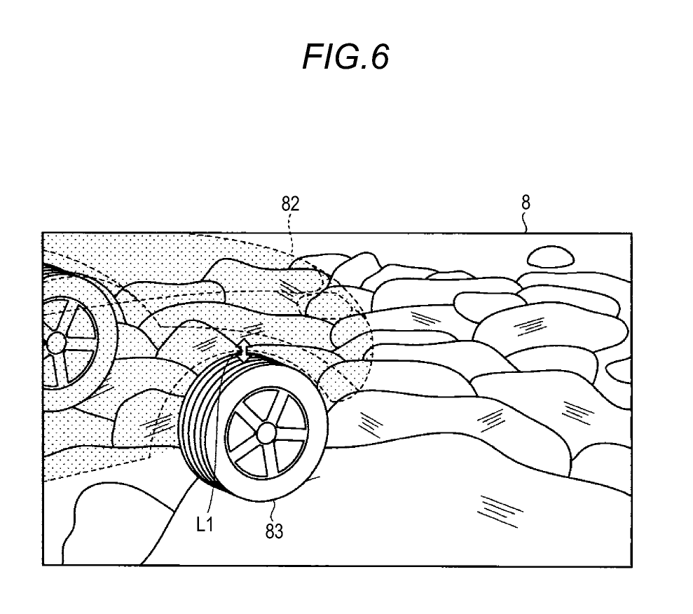

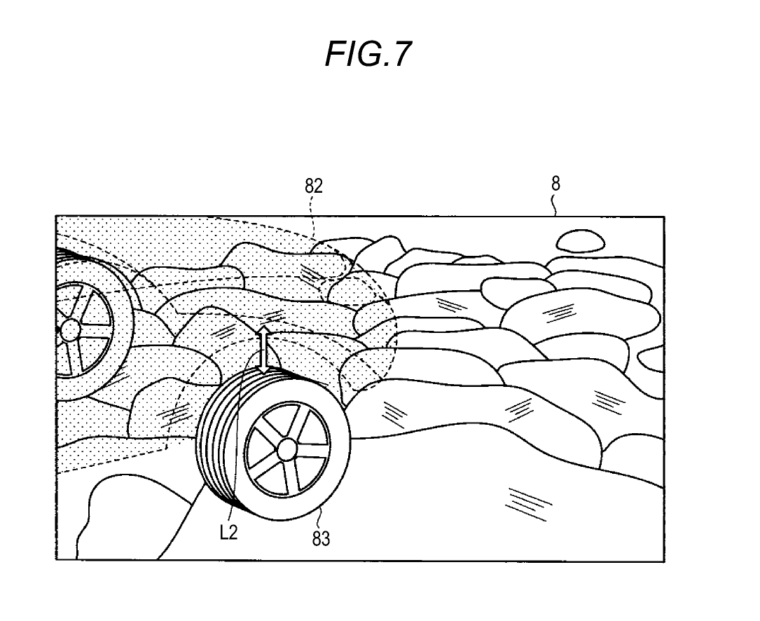

In an example, the state of the vehicle 1 includes a position of each wheel 3. Each wheel 3 may mainly vertically move with respect to the vehicle body 2 through expansion and contraction of a suspension. FIGS. 6 and 7 are views illustrating other display examples of the display screen 8 according to the first embodiment. These drawings illustrate display examples when the vehicle 1 is traveling on an off-road terrain (off road). According to FIG. 6, with respect to a portion indicating the vehicle body 2 included in the vehicle model image 81 (a vehicle body portion 82), the position of a portion indicating a right front wheel 3F (tire portion 83) is equal to a standard position. According to FIG. 7, the tire portion 83 is located below a standard position, with respect to the vehicle body portion 82. That is, a distance L2 between the vehicle body portion 82 and the tire portion 83 in the case of FIG. 7 is longer than a distance L1 between the vehicle body portion 82 and the tire portion 83 in the case of FIG. 6. In this manner, the periphery monitoring device reflects the vertical position change of each wheel 3 on the vehicle model image 81 in real time.

The periphery monitoring device may transparently display the vehicle body portion 82 so that the state of each wheel 3 may be visually recognized through the display screen 8. The transparent display may be a transparent or semi-transparent display. In the examples of FIGS. 6 and 7, the vehicle body portion 82 is semi-transparently displayed so that the state of the left front wheel 3F that is hidden behind the vehicle body 2 and is not seen in actuality may be visually recognized.

In another example, the state of the vehicle 1 includes turning ON/OFF a headlight. The periphery monitoring device may determine the turning ON/OFF of the headlight based on operation information on the headlight operation unit 20. When the headlight is turned ON, the periphery monitoring device, also on the display screen 8, changes a mode of a portion indicating the headlight in the vehicle model image 81 (hereinafter, referred to as a headlight portion), to a mode by which the turning ON of the headlight may be recognized. For example, the headlight portion is colored in a bright color such as yellow. When the headlight is turned OFF, the periphery monitoring device, also on the display screen 8, changes a mode of the headlight portion to a mode by which the turning OFF of the headlight may be recognized. For example, the headlight portion is colored in a dark color such as grey. In this manner, the periphery monitoring device reflects the turned ON/OFF state of the headlight on the vehicle model image 81 in real time.

In another example, the state of the vehicle 1 includes indication/no indication of the direction indicator. The periphery monitoring device may determine indication or no indication of the direction indicator based on operation information on the indicator operation unit 19. When the direction indicator is blinking, the periphery monitoring device changes a mode of a portion indicating a corresponding direction indicator within the vehicle model image 81 (hereinafter, referred to as “direction indicator portion”), to a mode by which blinking may be recognized. For example, the periphery monitoring device, on the display screen 8, displays the direction indicator portion in a blinking state. When the direction indicator is not blinking, the periphery monitoring device, on the display screen 8, displays the direction indicator portion in a non-blinking state. In this manner, the periphery monitoring device reflects an indication or no indication state of the direction indicator on the vehicle model image 81 in real time.

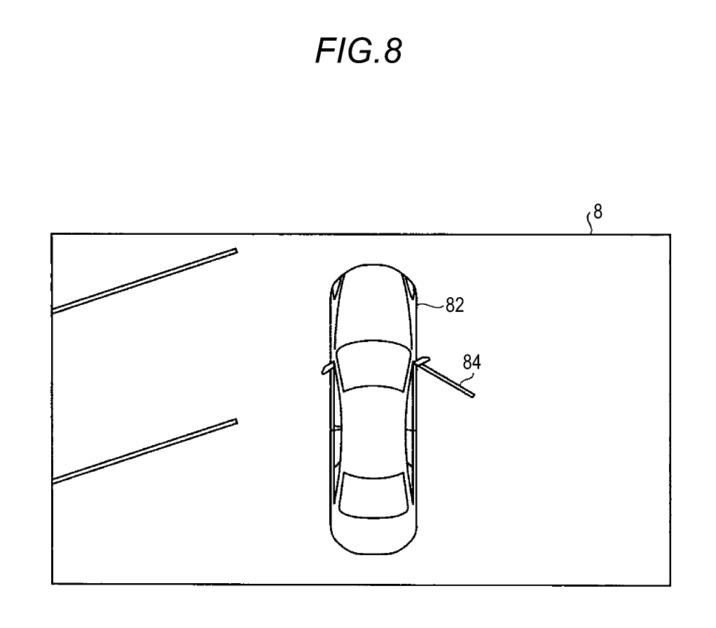

In another example, the state of the vehicle 1 includes an opened/closed state of each door 2d. The periphery monitoring device may determine the opened/closed state of each door 2d based on detection information of the door sensor 25. When any one of doors 2d is opened, the periphery monitoring device displays a portion of a corresponding door within the vehicle model image 81 (hereinafter, referred to as a “door portion”) in an opened state on the display screen 8. When any one of doors 2d is closed, the periphery monitoring device displays a corresponding door portion in a closed state, on the display screen 8. FIG. 8 is a view illustrating another display example of the display screen 8 according to the first embodiment. According to the drawing, an angle between a door portion 84 and a right side surface of the vehicle body portion 82 is about 60°, which indicates that the door 2d at a driver seat side is opened. In this manner, the periphery monitoring device reflects the opened/closed state of each door 2d on the vehicle model image 81 in real time. When a sensor capable of detecting an angle of the door 2d is employed as the door sensor 25, the periphery monitoring device may match an angle between the corresponding door portion 84 and the side surface of the vehicle body portion 82 within the vehicle model image 81 with a detected angle.

The periphery monitoring device may be configured such that the virtual viewpoint may be changed. For example, as illustrated in FIG. 5, the periphery monitoring device may display the peripheral environment and the vehicle model image 81 in the case where a virtual viewpoint is set at a diagonal left side in front of the vehicle 1, on the display screen 8. As illustrated in FIGS. 6 and 7, the periphery monitoring device may display the peripheral environment and the vehicle model image 81 in the case where a virtual viewpoint is set at a diagonal right side behind the vehicle 1, on the display screen 8. As illustrated in FIG. 8, the periphery monitoring device may display the peripheral environment and the vehicle model image 81 in the case where a virtual viewpoint is set above the vehicle 1, on the display screen 8. The periphery monitoring device may be configured such that a desired virtual viewpoint may be selected from a number of preset virtual viewpoints, or such that the user may input an arbitrary virtual viewpoint through, for example, the monitor operation unit 9 or the like.

In this manner, since the state of the external appearance of the vehicle 1 is reflected on the vehicle model image 81 in real time, the user may objectively check the state of the vehicle 1 while staying in the vehicle compartment 2a. That is, the periphery monitoring device may display the state of the vehicle 1 in an objectively and easily understandable manner.

According to another feature of the periphery monitoring device according to the first embodiment, the periphery monitoring device stereoscopically displays an image indicating the peripheral environment, which includes a portion under the floor of the vehicle 1, on the display screen 8. Specifically, the periphery monitoring device may project the image indicating the peripheral environment, which includes the portion under the floor of the vehicle 1, on topographical data, thereby stereoscopically displaying the image indicating the peripheral environment. While stereoscopically displaying the image indicating the peripheral environment, the periphery monitoring device reflects a vertical movement of each wheel 3 on the vehicle model image 81. Accordingly, screen displaying in FIGS. 6 and 7 is performed. Since both the vehicle 1 and the peripheral environment are stereoscopically displayed to be superimposed on the display screen 8, the user may visually recognize whether each wheel 3 is in contact with the ground, on the display screen 8, so that the convenience of the periphery monitoring device is improved.

The periphery monitoring device generates the image indicating the peripheral environment using images captured by the imaging units 16. Here, in the first embodiment, it is impossible for any imaging unit 16 to capture an image indicating a road surface under the floor of the vehicle 1 in real time. Accordingly, the periphery monitoring device saves respective images captured by the imaging units 16a to 16d in the past, and generates a current image indicating the road surface under the floor of the vehicle 1 based on the stored images. For example, when the vehicle 1 travels straight ahead, after the imaging unit 16a captures an image at a certain timing, the vehicle 1 passes through a road surface captured on the image at a later timing. The periphery monitoring device may save the image captured by the imaging unit 16a at a slightly previous timing, and use the image as an image indicating a road surface through which the vehicle 1 is passing. Alternatively, another imaging unit may be provided under the floor of the vehicle 1 so that the periphery monitoring device may acquire an image indicating a road surface under the floor from the imaging unit in real time. Depending on the traveling direction, the periphery monitoring device may acquire an image indicating a road surface through which the vehicle 1 is passing, from an image captured by the imaging unit 16 other than the imaging unit 16a at a slightly previous timing.

The detection range of the laser range scanner 15, according to the installation example of FIG. 2, is limited to a partial range including a forward road surface of the vehicle 1. Similarly to the image indicating the peripheral environment, in relation to the topographical data as well, the periphery monitoring device generates topographical data of a road surface including a portion under the floor of the vehicle 1 based on data detected at a slightly previous timing. Alternatively, another laser range scanner 15 may be provided under the floor of the vehicle 1 so that the periphery monitoring device may calculate topographical data of a road surface under the floor based on the detection information from the laser range scanner 15 in real time. The laser range scanners 15 may also be provided at the left and right sides and the rear side of the vehicle body 2.

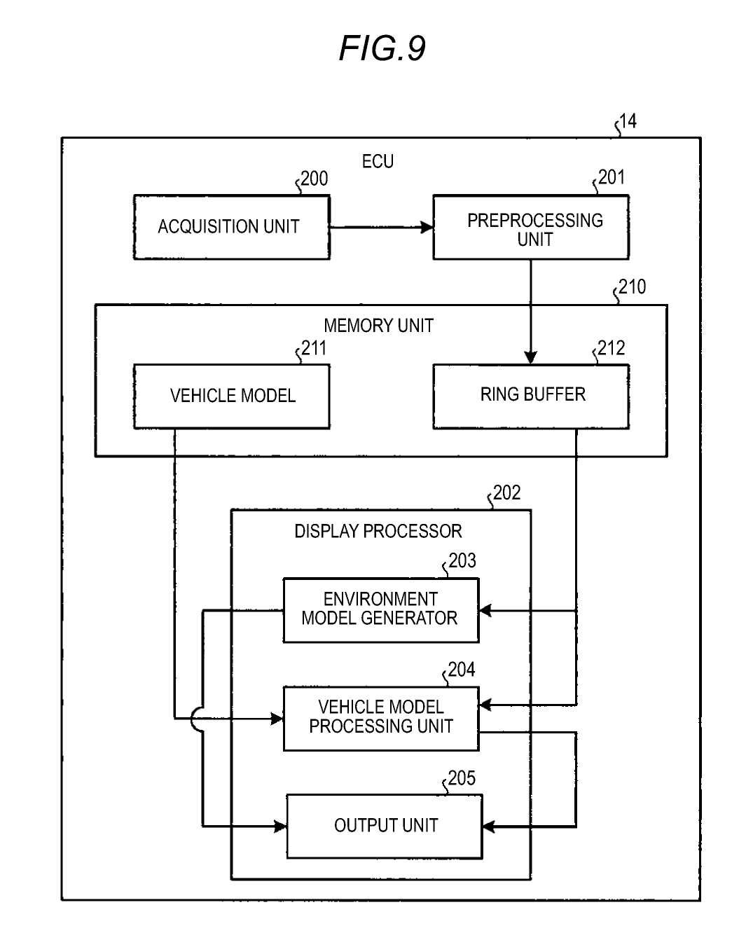

FIG. 9 is a block diagram illustrating a functional configuration of the ECU 14 as the periphery monitoring device according to the first embodiment. The CPU 14a implements an acquisition unit 200, a preprocessing unit 201, and a display processor 202 by executing a program stored in advance in the ROM 14b. The display processor 202 includes an environment model generator 203, a vehicle model processing unit 204, and an output unit 205. The ECU 14 implements a memory unit 210 in which data is temporarily stored. The memory unit 210 is secured on, for example, the RAM 14c. The program for implementing these functional configurations may be provided via any computer readable recording medium other than the ROM 14b. The ECU 14 implements a ring buffer 212 on the memory unit 210. The ECU 14 stores the vehicle model 211 on the memory unit 210. For example, the vehicle model 211 is stored in the SSD 14e in advance, and the ECU 14 loads the vehicle model 211 from the SSD 14e to the memory unit 210 within the RAM 14c when activated. Some or all of the acquisition unit 200, the preprocessing unit 201, the display processor 202, the environment model generator 203, the vehicle model processing unit 204, and the output unit 205 may be implemented by a hardware circuit, or a combination of a hardware circuit and software (program).

The acquisition unit 200 acquires images from the imaging units 16. The acquisition unit 200 acquires point group data from the laser range scanner 15.

The acquisition unit 200 acquires various pieces of information from various sensors provided in the vehicle 1 and various operation units provided in the vehicle 1. The acquisition unit 200 according to the first embodiment acquires vehicle height information from the vehicle height sensors 24 and opening/closing information from the door sensors 25, as information corresponding to the state of the vehicle 1. The acquisition unit 200 acquires various pieces of operation information input to the indicator operation unit 19 and the headlight operation unit 20 as information corresponding to the state of the vehicle 1. The acquisition unit 200 acquires acceleration information from the acceleration sensors 27.

The acquisition unit 200 correlates images, point group data, various pieces of detection information, and various pieces of operation information which are acquired at substantially identical times, with each other.

The preprocessing unit 201 properly processes any information among various pieces of information acquired by the acquisition unit 200.

In the first embodiment, as an example, the preprocessing unit 201 converts the point group data acquired from the laser range scanner 15 into topographical data. The topographical data expresses the road surface three-dimensional shape by, for example, a polygon model method. The expression method of the three-dimensional shape is not limited to the polygon model. As a method of expressing the three-dimensional shape, any other methods such as, for example, a surface model, a wire frame model, and a solid model may be employed.

The preprocessing unit 201 calculates angle information (a pitch angle and a roll angle) of the vehicle 1 based on the acceleration information received from the two acceleration sensors 27. The pitch angle refers to an angle indicating an inclination around the left-right axis of the vehicle 1, and the roll angle refers to an angle indicating an inclination around the front-rear axis of the vehicle 1.

The preprocessing unit 201 performs correction on an image of the peripheral environment in front of the vehicle 1, which is captured by the imaging unit 16a, and topographical data, based on the pitch angle and the roll angle. Since the image and the topographical data are viewed from the installation position of the laser range scanner 15 and the imaging unit 16 provided in the vehicle 1, as a viewpoint, the peripheral environment has been imaged at a tilted viewpoint. The preprocessing unit 201 corrects the image captured slantly by the inclination of the viewpoint, based on the pitch angle and the roll angle, thereby unifying inclinations of viewpoints of plural images captured at different timings.

The preprocessing unit 201 estimates the position of the vehicle 1. The position estimation method of the vehicle 1 is not limited to a specific method. Here, in an example, the preprocessing unit 201 calculates an optical flow using a previously captured image and a currently captured image, calculates a movement amount of the vehicle 1 between timings when the images have been captured, based on the calculated optical flow, and estimates the position of the vehicle 1 based on the movement amount. The position estimation method of the vehicle 1 is not limited thereto. For example, the preprocessing unit 201 may estimate the position of the vehicle 1 based on other information such as GPS information (not illustrated), a rotation amount of the wheel 3, steering information, and the like.

The preprocessing unit 201 stores the corrected image and the corrected topographical data in the ring buffer 212 in association with the position information and angle information (the pitch angle and the roll angle) of the vehicle 1, various pieces of detection information, and various pieces of operation information.

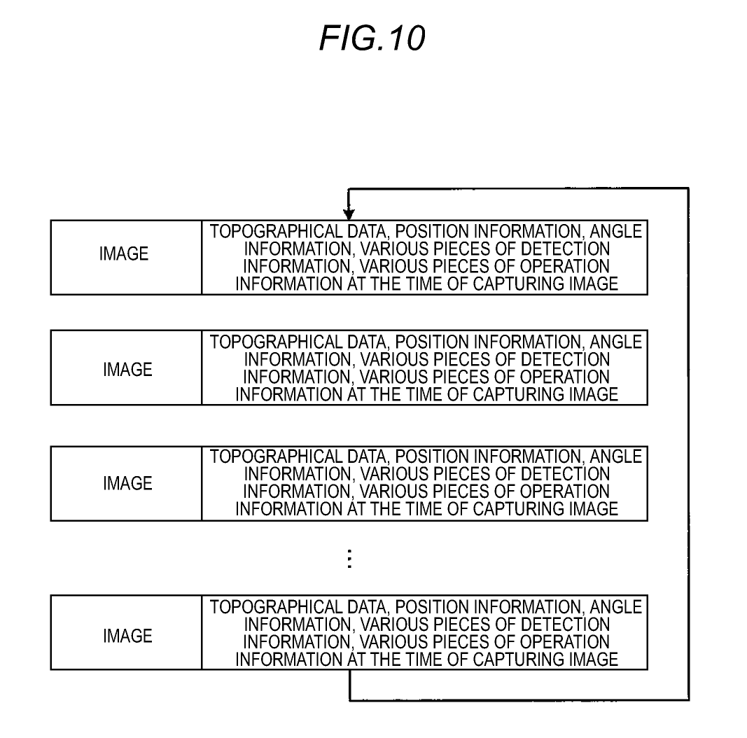

FIG. 10 is a view illustrating the structure of the ring buffer 212. As illustrated in the drawing, an image, and topographical data at the time when the corresponding image is captured, position information and angle information of the vehicle 1 various pieces of detection information, and various pieces of operation information at the time of capturing the corresponding image are accumulated in the ring buffer 212 in association with each other. The ring buffer 212 is a memory area that is logically arranged in a ring shape. In the ring buffer 212, in response to the storage request of the preprocessing unit 201, the corresponding image or the like requested to be stored is overwritten and stored in the oldest updated area.

In the first embodiment, an interval at which images or the like are stored in the ring buffer 212 is not limited, but the storage interval is set to a value that is not too long such that, for example, an image obtained by capturing the road surface through which the vehicle 1 is passing, and topographical data indicating unevenness of the road surface may be acquired at any timing from at least a previously stored image and previously stored topographical data. Here, it is assumed that the storage into the ring buffer 212 is performed at a sufficiently short time interval such that an image lately stored in the ring buffer 212 is considered as a real time image. In another configuration in which the real time image is acquired through a different buffer from the ring buffer 212, the interval at which images are stored in the ring buffer 212 is not limited to the above.

The real time image is an image that may be regarded by the user as an image captured at the current timing, and the elapsed time from when the corresponding image is captured until the current time is short enough to be negligible. Among images stored in the ring buffer 212, images other than the real time image are referred to as past images. That is, among images stored in the ring buffer 212, images other than the lately stored image correspond to past images. The topographical data stored in the ring buffer 212 in association with the real time image is referred to as real time topographical data. The topographical data stored in the ring buffer 212 in association with the past image is referred to as past topographical data.

The display processor 202 performs a display processing on the display screen 8.

The environment model generator 203 generates an image indicating the peripheral environment including a road surface under the floor of the vehicle 1. The environment model generator 203 acquires a real time image and a past image from the ring buffer 212, and synthesizes the acquired images, thereby generating the image indicating the peripheral environment. The synthesis of images seamlessly connects plural images.

The environment model generator 203 acquires real time topographical data and past topographical data from the ring buffer 212, and synthesizes the acquired topographical data, thereby generating the topographical data indicating the peripheral environment including the road surface under the floor of the vehicle 1. The synthesis of topographical data seamlessly connects plural topographical data.

The environment model generator 203 projects the generated image on the generated topographical data through a method such as texture mapping. The information indicating a stereoscopic shape of the peripheral environment, which is generated through the processing, is referred to as an environment model. When a portion lacking topographical data is present in the image range, the environment model generator 203 may process the corresponding portion through an arbitrary method. For example, the environment model generator 203 may complement the topographical data-lacking portion with a planar shape.

The vehicle model processing unit 204 processes the vehicle model 211 based on information corresponding to the state of the vehicle 1. Specifically, the vehicle model processing unit 204 acquires angle information, various pieces of detection information, and various pieces of operation information corresponding to the real time image. The vehicle model processing unit 204 processes some or all of the shape, color and inclination of the vehicle model 211 based on the various pieces of detection information or various pieces of operation information. That is, the vehicle model processing unit 204 reflects the state of the vehicle 1 determined based on the various pieces of detection information or the various pieces of operation information, on the state of the vehicle model 211. The vehicle model processing unit 204 tilts the vehicle model 211 according to the acquired angle information.

The vehicle model 211 is data indicating a three-dimensional shape of the vehicle 1. As a method of expressing the three-dimensional shape of the vehicle model 211, any method may be employed similarly to the above described topographical data.

The output unit 205 arranges the environment model generated by the environment model generator 203 and the vehicle model 211 processed by the vehicle model processing unit 204 in the same virtual space. The output unit 205 generates an image frame to be displayed on the display screen 8 based on the environment model and the vehicle model 211 arranged in the virtual space, and outputs the generated image frame to the display screen 8. Thus, as illustrated in FIGS. 5 to 8, an image including the vehicle model image 81 superimposed on the image indicating the peripheral environment is output to the display screen 8. In this description, after the environment model and the vehicle model 211 are arranged in the virtual space, an image from a virtual viewpoint is computed. Meanwhile, the image indicating the peripheral environment and the vehicle model image 81 may be separately generated, and then the vehicle model image 81 may be superimposed on the image indicating the peripheral environment.

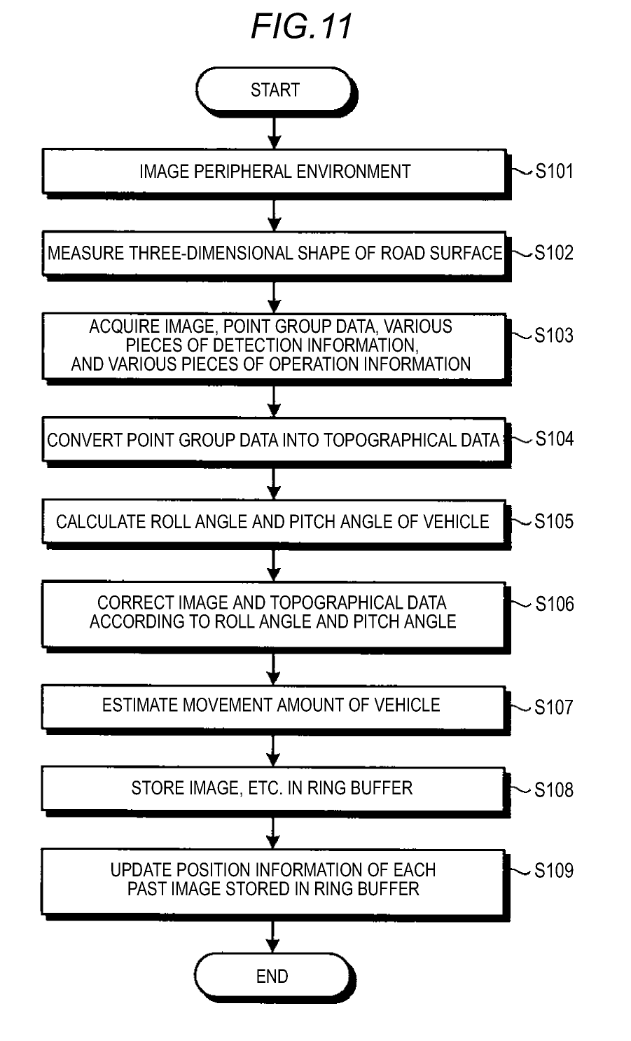

Hereinafter, descriptions will be made on an operation of the periphery monitoring device according to the first embodiment as configured above. FIG. 11 is a flow chart illustrating the procedure of a storage process of an image in the periphery monitoring device according to the first embodiment. The process in FIG. 11 is executed for each cycle in which various data are stored in the ring buffer 212.

First, the imaging units 16a to 16d capture an image of a peripheral environment of the vehicle 1 (S101). Particularly, the imaging unit 16a captures an image of a region including a road surface in the traveling direction of the vehicle 1. The laser range scanner 15 measures a three-dimensional shape of the road surface in the forward direction of the vehicle 1 (S102).

Thereafter, the acquisition unit 200 acquires the images from the imaging units 16a to 16d, point group data as a measurement result from the laser range scanner 15, detection information from various sensors, and operation information from various operation units (S103). The detection information includes, for example, vehicle height information from the four vehicle height sensors 24, opening/closing information from the four door sensors 25, and acceleration information from the two acceleration sensors 27. The operation information includes operation information from the indicator operation unit 19 and the headlight operation unit 20. The types of the detection information and the types of the operation information may be properly changed.

Then, the preprocessing unit 201 converts the point group data into topographical data (S104).

Subsequently, the preprocessing unit 201 calculates a roll angle and a pitch angle of the vehicle 1 based on the acceleration information from the acceleration sensors 27 among detection information pieces acquired by the acquisition unit 200 (S105). Then, the preprocessing unit 201 performs correction on the image acquired by the acquisition unit 200 and the topographical data obtained through conversion, according to the roll angle and the pitch angle (S106).

The preprocessing unit 201 estimates a movement amount of the vehicle 1 from the point in time when an image was captured last time to the point in time when an image has been captured this time based on an optical flow, (S107). As described above, the movement amount estimation method is not limited to the method using the optical flow.

Then, the preprocessing unit 201 stores the corrected image in the oldest updated area of the ring buffer 212 in an overwriting manner (S108). Here, the preprocessing unit 201 stores the corrected topographical data, the position information and angle information of the vehicle 1, various pieces of detection information, and various pieces of operation information in the ring buffer 212 in association with each image. Here, in an example, the position information of the vehicle 1 is information with the current position as a reference (that is, origin), but the reference of the position information is not limited thereto. In the processing in S108, as position information, origin position information is stored.

Thereafter, the preprocessing unit 201 updates position information which was stored in the ring buffer 212 when each image was captured in the past, to position information based on current position information, according to the calculated movement amount (S109). By the processing in S109, an image storage process in the present storage cycle is completed.

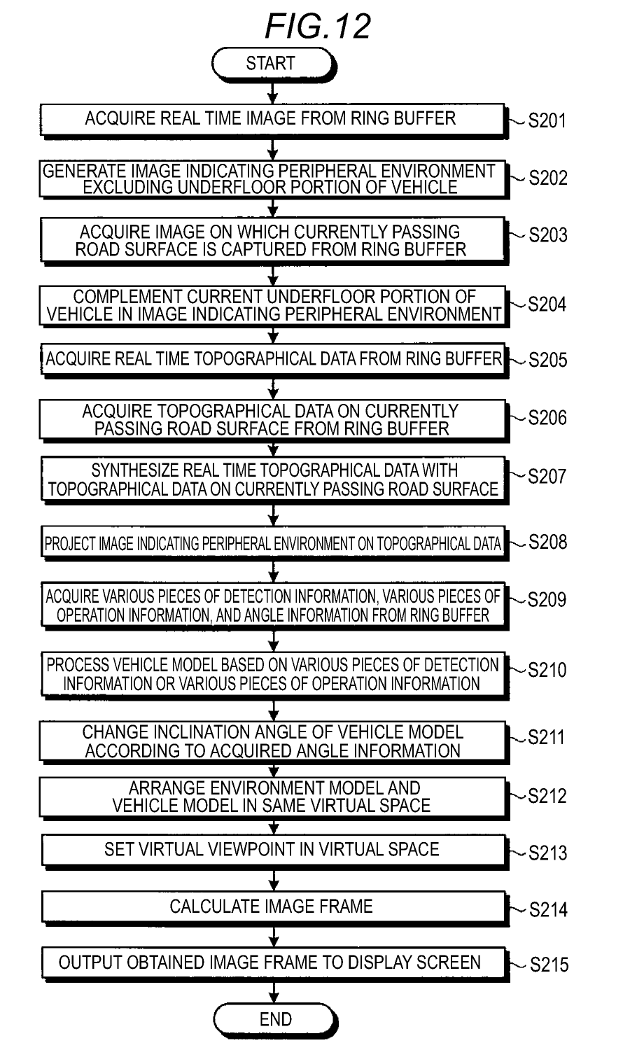

FIG. 12 is a flow chart illustrating the procedure of a process of controlling a display in the periphery monitoring device according to the first embodiment. The drawing illustrates a process until one image frame is output to the display screen 8. When the series of processings illustrated in the drawing are repeatedly executed at a predetermined control cycle, an image frame is changed at every control cycle, and as a result, the user may recognize the displayed contents on the display screen 8 as an image. The control cycle is equal to, for example, the cycle at which an image is stored into the ring buffer 212. The control cycle may be different from the cycle at which the image is stored into the ring buffer 212.

First, the environment model generator 203 acquires a real time image from the ring buffer 212 (S201). That is, the environment model generator 203 acquires a lately stored image from the ring buffer 212. Here, the environment model generator 203 acquires images captured by the imaging units 16a to 16d.

The environment model generator 203 processes the acquired images captured by the imaging units 16a to 16d, thereby generating an image indicating the peripheral environment excluding an underfloor portion of the vehicle 1 (S202). The processings on the images include cut-out, masking, synthesis of plural images, filtering of a part or whole of an image, correction, and viewpoint conversion. The correction is, for example, distortion correction or gamma correction. For example, the viewpoint conversion is to generate an image viewed from another viewpoint, such as a bird's eye view image, from an image obtained by each of the imaging units 16. In an example, the environment model generator 203 generates one image by seamlessly synthesizing the images captured by the imaging units 16a to 16d.

The imaging units 16a to 16d capture images of the peripheral environment in front of and behind the vehicle 1, and the left and right sides of the vehicle 1. Thus, the images obtained by the imaging units 16a to 16d may be synthesized so as to obtain an image indicating the peripheral environment excluding the underfloor portion of the vehicle 1, which is a blind spot. The blind spot portion may be wider than the underfloor portion of the vehicle 1, and in this case, a portion indicating the blind spot portion may be complemented by the following processings (S203 and S204).

The environment model generator 203 may perform viewpoint conversion in S202. For example, the environment model generator 203 may generate a bird's eye view image. Although not particularly specified below, viewpoint conversion may be performed on an image and topographical data at any timing. Any processing other than the viewpoint conversion may be executed on the whole or part of the image and the topographical data at any timing.

Thereafter, the environment model generator 203 acquires an image on which a road surface through which the vehicle 1 is now passing is captured among the past images stored in the ring buffer 212 (S203). The environment model generator 203 selects an image on which the road surface through which the vehicle 1 is now passing is captured among the past images stored in the ring buffer 212 by an arbitrary method. In an example, based on position information in association with each image, the image on which the road surface through which the vehicle 1 is now passing is captured is selected.

Then, the environment model generator 203 complements the current underfloor portion of the vehicle 1 in the image generated by the processing in S202, based on the acquired past image (S204). For example, the environment model generator 203 cuts out a portion on which the road surface through which the vehicle 1 is now passing, that is, the current underfloor road surface of the vehicle 1, is captured, from the acquired past image, properly performs viewpoint conversion on the cut-out image, and seamlessly synthesizes the viewpoint-converted image with the image generated by the processing in S202.

When the road surface through which the vehicle 1 is now passing is divided and divided road surfaces are captured on separate images, the environment model generator 203 may acquire all the separate images. The separate images may be images captured by different imaging units 16, or may be images captured at different timings. In the processing in S204, the environment model generator 203 cuts out portions on which the road surface through which the vehicle 1 is now passing is captured from the plural acquired images, and complements the current underfloor portion of the vehicle 1 using the plural cut-out images.

Subsequently, the environment model generator 203 acquires real time topographical data from the ring buffer 212 (S205). The environment model generator 203 acquires topographical data on a road surface through which the vehicle 1 is now passing among the past topographical data pieces stored in the ring buffer 212 (S206). The environment model generator 203 seamlessly synthesizes the topographical data acquired by the processing in S205 with the topographical data acquired by the processing in S206 (S207).

Similarly to the synthesis of images, in relation to the topographical data, the environment model generator 203 may synthesize three or more pieces of topographical data. The environment model generator 203 may properly perform processings including viewpoint conversion on each topographical data piece before synthesis.

Subsequently, the environment model generator 203 projects the image indicating the peripheral environment completed by the processing in S204 on the topographical data completed by the processing in S206 (S208). For example, when a polygon model is employed in the topographical data, the environment model generator 203 pastes a corresponding portion in the image indicating the peripheral environment on each of a large number of surfaces constituting the terrain. Through S207, the environment model is completed.

Then, the vehicle model processing unit 204 acquires various pieces of detection information and various pieces of operation information in association with the real time image from the ring buffer 212 (S209). The vehicle model processing unit 204 processes some or all of the shape, color and inclination of the vehicle model 211 based on the various pieces of detection information or various pieces of operation information (S210).

In the processing in S210, in an example, the vehicle model processing unit 204 calculates an extension/contraction amount of a suspension of each wheel 3 based on the vehicle height information from the vehicle height sensor 24 for each wheel 3, which is included in the acquired detection information. Then, the vehicle model processing unit 204 calculates a position of each wheel 3 based on the extension/contraction amount of the suspension of each wheel 3. The vehicle model processing unit 204 reflects the calculated position of each wheel 3 on the vehicle model 211. For example, the vehicle model 211 includes a model of each wheel 3 and a model of the vehicle body 2 as separate data such that the relative positional relationship between the model of each wheel 3 and the model of the vehicle body 2 may be freely changed. When a certain wheel 3 is extended, the vehicle model processing unit 204 moves the position of the model of the corresponding wheel 3 included in the vehicle model 211 downward by the extension amount. When a certain wheel 3 is contracted, the vehicle model processing unit 204 moves the position of the model of the corresponding wheel 3 included in the vehicle model 211 upward by the contraction amount. In this manner, the vehicle model processing unit 204 changes a distance between the model of the wheel 3 and the model of the vehicle body 2 according to the extension/contraction amount of the suspension.

The vehicle model processing unit 204 may make a predetermined portion of the vehicle model 211 transparent or semi-transparent. For example, the vehicle model processing unit 204 may make the model of the vehicle body 2 included in the vehicle model 211 transparent or semi-transparent.

In the processing in S210, in another example, the vehicle model processing unit 204 determines the turning ON/OFF of the headlight based on operation information input to the headlight operation unit 20. The vehicle model processing unit 204 changes the color of a portion of the vehicle model 211 corresponding to the headlight (that is, a headlight model) according to the turning ON/OFF of the headlight.

In another example, the processing in S210 includes indication/no indication of the direction indicator. The vehicle model processing unit 204 determines indication or no indication of the direction indicator based on operation information input to the indicator operation unit 19. The vehicle model processing unit 204 places a display of a portion of the vehicle model 211 corresponding to the direction indicator (that is, a direction indicator model) in a blinking or non-blinking state according to the indication/no indication of the direction indicator. Blinking of the portion of the vehicle model 211 corresponding to the direction indicator refers to repeatedly turning ON/OFF the portion of the vehicle model 211 corresponding to the direction indicator. When the portion of the vehicle model 211 corresponding to the direction indicator is caused to blink, the vehicle model processing unit 204 determines whether to place the portion corresponding to the direction indicator at an image frame to be generated this time in a turned-ON mode or a turned-OFF mode according to an image frame which was generated in the past.

In the processing in S210, in another example, the vehicle model 211 includes, for example, a portion of the vehicle model 211 corresponding to each door and a model portion of the vehicle model 211 corresponding to the portion of the vehicle body 2 as separate data such that the relative positional relationship between the model of the vehicle body 2 and the model of each door 2d may be freely changed. The vehicle model processing unit 204 changes an angle between the model of the corresponding door included in the vehicle model 211 and the model of the vehicle body 2 included in the vehicle model 211 according to detection information from each door sensor 25.

Subsequently to the processing in S210, the vehicle model processing unit 204 changes an inclination angle of the vehicle model 211, according to the acquired angle information (S211).

Thereafter, the output unit 205 arranges the environment model and the vehicle model 211 processed in S210 in the same virtual space (S212). In the arrangement, the output unit 205 adjusts the positional relationship between the environment model and the processed vehicle model 211 so that an actual relationship between the vehicle 1 and the peripheral environment corresponds to the relationship between the environment model and the processed vehicle model 211. The image as a source of environment model creation is associated with position information and angle information at the timing when the corresponding image has been captured, when stored in the ring buffer 212. The direction of an optical axis of each of the imaging units 16 is conventionally known or may be acquired. The output unit 205 may adjust the positional relationship between the environment model and the processed vehicle model 211 based on these information pieces.

Then, the output unit 205 sets a virtual viewpoint in the virtual space (S213), and calculates an image (image frame) to be output to the display screen 8 based on the virtual viewpoint (S214). The output unit 205 outputs the image (image frame) obtained through calculation to the display screen 8 (S215), and the process of controlling the display is completed.

As described above, according to the first embodiment, the periphery monitoring device acquires an image indicating the peripheral environment of the vehicle 1, and information corresponding to the state of the vehicle 1, and processes the vehicle model 211 according to the acquired information. The periphery monitoring device superimposes the processed vehicle model 211 on the image indicating the peripheral environment, and outputs the image indicating the peripheral environment on which the vehicle model 211 is superimposed to the display screen 8. Thus, the state of the vehicle 1 is reflected on the vehicle model image 81 in real time, and thus the user may objectively check the state of the vehicle 1 while staying in the vehicle compartment 2a. That is, the periphery monitoring device may display the state of the vehicle 1 in an objectively and easily understandable manner.

The periphery monitoring device acquires an extension/contraction amount of a suspension as information corresponding to the state of the vehicle 1. The periphery monitoring device changes a distance between a model of the vehicle body 2 and a model of the wheel 3 included in the vehicle model 211 by the extension/contraction amount of the suspension. Accordingly, the user may grasp the state of the wheel 3 according to the peripheral environment while staying in the vehicle compartment 2a.

When changing a relative position between the model of the vehicle body 2 and the model of the wheel 3, the periphery monitoring device may generate an afterimage of the model of the wheel 3 at a position before the change of the relative position. In an example, the vehicle model processing unit 204 duplicates the model of the wheel 3 at the position before the change of the relative position, and sets the transparency of the duplicated model of the wheel 3 to be higher than that of the model of the wheel 3 disposed at a position after the change of the relative position (that is, the model of the wheel 3 indicating a real time state). Accordingly, since the tire portion 83 before the position change is displayed as an afterimage on the display screen 8, the user may find out how the position of the wheel 3 changes. The number of displayable afterimages of the tire portion 83 is not limited to one for each wheel 3. Plural afterimages may be displayed for each wheel 3. The plural afterimages may be displayed to be located corresponding to positions at different timings, respectively. Alternatively, an afterimage may be generated and displayed each time the relative position is changed by a predetermined amount. The vehicle model processing unit 204 makes a change such that the transparency of the afterimage increases with elapse of time, and thus the corresponding tire portion 83 may gradually become transparent with elapse of time, and may be finally erased from the display screen 8. The erasing method of the afterimage is not limited to the above.

A vehicle height adjusting device may be provided in the vehicle 1. In this case, while the vehicle height adjusting device is changing the vehicle height, the periphery monitoring device successively acquires the extension/contraction amount of a suspension, and reflects the acquired extension/contraction amount on the vehicle model 211 in real time. During adjustment of the vehicle height, the change of the vehicle height may be reflected on the vehicle model image 81 in real time so that a high amusement presentation may be made.

When the vehicle height sensor 24 is out of order, the periphery monitoring device may execute an arbitrary processing in relation to the processing of the vehicle model 211. For example, when the vehicle height sensor 24 is out of order, the periphery monitoring device sets the position of the model of the wheel 3 with respect to the model of the vehicle body 2 as a reference position. In another example, when the vehicle height sensor 24 is out of order, the periphery monitoring device may display the model of the wheel 3 corresponding to the failed vehicle height sensor 24 in a color different from a usual color.

The periphery monitoring device may reflect a steering angle or a rotational speed of each wheel 3 on the model of the wheel 3. For example, the periphery monitoring device changes the steering angle of the model of the wheel 3 according to the steering angle information from the steering angle sensor 26. The user may easily grasp the correspondence between the peripheral environment and the steering angle of the wheel 3. For example, the periphery monitoring device displays the model of the wheel 3 in a rotational state according to the detection information from the wheel speed sensor 22. The user may grasp the rotation of the wheel 3 according to the peripheral environment.

The periphery monitoring device may output the image indicating the peripheral environment, as it is, through viewpoint conversion to the display screen 8, but may process the image indicating the peripheral environment into an image stereoscopically indicating the peripheral environment and then output the processed image. Specifically, the periphery monitoring device further acquires the measurement result of the road surface three-dimensional shape from the laser range scanner 15, and reflects the image indicating the peripheral environment on the road surface three-dimensional shape, thereby generating an environment model. Then, the periphery monitoring device displays the vehicle model 211 together with the environment model on the display screen 8. Accordingly, the user may recognize whether the wheel 3 is in contact with the ground through the display screen 8.

The periphery monitoring device may emphatically display whether the wheel 3 is in contact with the ground. In an example, the periphery monitoring device changes a color of the model of the wheel 3 depending on whether the wheel 3 is in contact with the ground. In another example, the periphery monitoring device changes the transparency of the model of the wheel 3 depending on whether the wheel 3 is in contact with the ground. The method of determining whether the wheel 3 is in contact with the ground is not limited to a specific method. In an example, the periphery monitoring device arranges the vehicle model 211 and the environment model in a virtual space, and determines whether the model of the wheel 3 is in contact with the environment model, from the positional relationship between the models. In another example, the periphery monitoring device determines whether the wheel 3 is idling based on the detection information from the wheel speed sensor 22 and the movement amount of the vehicle 1. Then, the periphery monitoring device determines whether the wheel 3 is in contact with the ground depending on whether the wheel 3 is idling.

The periphery monitoring device may emphatically display whether the wheel 3 is slipping. In an example, the periphery monitoring device changes a color of the model of the wheel 3 depending on whether the wheel 3 is slipping. In another example, the periphery monitoring device changes the transparency of the model of the wheel 3 depending on whether the wheel 3 is slipping. For example, the periphery monitoring device sets the transparency of the model of a slipping wheel 3 to be higher than that of the model of a non-slipping wheel 3. The method of determining whether the wheel 3 is slipping is not limited to a specific method.

The periphery monitoring device acquires operation information from an operation unit of a lighting device such as a direction indicator or a headlight (the indicator operation unit 19, and the headlight operation unit 20) as information corresponding to the state of the vehicle 1. The periphery monitoring device determines whether the lighting device is turned ON/OFF based on the operation information. The periphery monitoring device changes a color of a corresponding lighting device model included in the vehicle model 211 according to the turning ON/OFF of the lighting device. Accordingly, the user may check whether the lighting device is turned ON/OFF through the display screen 8.

In relation to lighting devices other than the direction indicator and the headlight, such as a taillight, a side marker light, a number plate light, a front fog lamp, a rear fog lamp, a brake light, a reversing light, a parking light, an auxiliary brake light, or an emergency flashing indicator, the periphery monitoring device may change a color of a corresponding lighting device model included in the vehicle model 211 according to the turning ON/OFF of the corresponding lighting device. The periphery monitoring device may determine whether the lighting device is turned ON/OFF based on information other than the operation information. For example, a sensor for detecting whether the lighting device is turned ON/OFF may be provided in the vehicle 1, and the periphery monitoring device may determine whether the lighting device is turned ON/OFF based on detection information output from the sensor. Regarding a lighting device that is turned ON/OFF depending on another operation, the periphery monitoring device may determine whether the lighting device is turned ON/OFF based on detection information from a sensor for detecting the corresponding operation. When the direction indicator is blinking, the periphery monitoring device may display a mode of the direction indicator included in the vehicle model 211 in a blinking state in synch with the blinking of the direction indicator.

The periphery monitoring device acquires the detection information from the door sensor 25 as information corresponding to the state of the vehicle 1. The detection information from the door sensor 25 indicates whether the door 2d is opened or closed. The periphery monitoring device changes the angle between the model of the door 2d and the model of the vehicle body 2 depending on whether the door 2d is opened or closed. Accordingly, the user may check whether the door 2d is opened or closed through the display screen 8.

The periphery monitoring device may change a mode of a model of a corresponding door mirror 2f included in the vehicle model 211 depending on whether the door mirror 2f is opened or closed. The periphery monitoring device may determine the opened/closed state of the door mirror 2f based on input to a switch used for operating opening/closing of the door mirror 2f. The periphery monitoring device may reflect the state of another component, such as an operation of a wiper blade, on a mode of a corresponding model included in the vehicle model 211. The periphery monitoring device may change a mode of a corresponding window model included in the vehicle model 211 depending on whether a window provided in the door 2d is opened or closed. The periphery monitoring device may determine whether the window is opened or closed based on input to a switch used for operating the window. Alternatively, a sensor for detecting whether the window is opened or closed may be provided, and the periphery monitoring device may determine whether the window is opened or closed based on detection information from the corresponding sensor. The periphery monitoring device may acquire an opening amount of a window based on operation information of a switch used for operating the window or detection information from the sensor of detecting whether the window is opened or closed, and reflect the acquired amount on a mode of a corresponding window included in the vehicle model 211.

In the above description, as the state of the vehicle 1 to be reflected on the vehicle model image 81, external aspects of the vehicle 1 have been exemplified. However, the state of the vehicle 1 to be reflected on the vehicle model image 81 is not limited thereto. The periphery monitoring device may reflect a component that is difficult to externally visually recognize in the vehicle 1 in actuality or a setting that is difficult to externally visually recognize, on the vehicle model image 81.

In an example, the state of the vehicle 1 includes locking/unlocking of a differential gear (not illustrated). The vehicle model 211 includes a model of the differential gear. The periphery monitoring device displays the model of the vehicle body 2 in a semi-transparent state, and displays a model of a suspension. Here, in the display of the differential gear, the periphery monitoring device changes the display mode of a model of the differential gear depending on the locked state or unlocked state. For example, when the differential gear is locked, the periphery monitoring device colors the model of the differential gear in red. When the differential gear is unlocked, the periphery monitoring device colors the model of the differential gear in blue. The periphery monitoring device may determine whether the differential gear is locked or unlocked based on, for example, an input to a switch (not illustrated) for changing a locked state and an unlocked state.

In another example, the state of the vehicle 1 includes extension/contraction of a suspension (not illustrated). The vehicle model 211 includes a model of the suspension for each wheel 3. The periphery monitoring device displays the model of the vehicle body 2 in a semi-transparent state, and displays the model of the differential gear for each wheel 3. The periphery monitoring device reflects the extension/contraction amount of each suspension in real time on the model of the suspension.

In this manner, the periphery monitoring device may display a component that is difficult to externally visually recognize or a setting that is difficult to externally visually recognize, in a visually recognizable mode.

### Second Embodiment

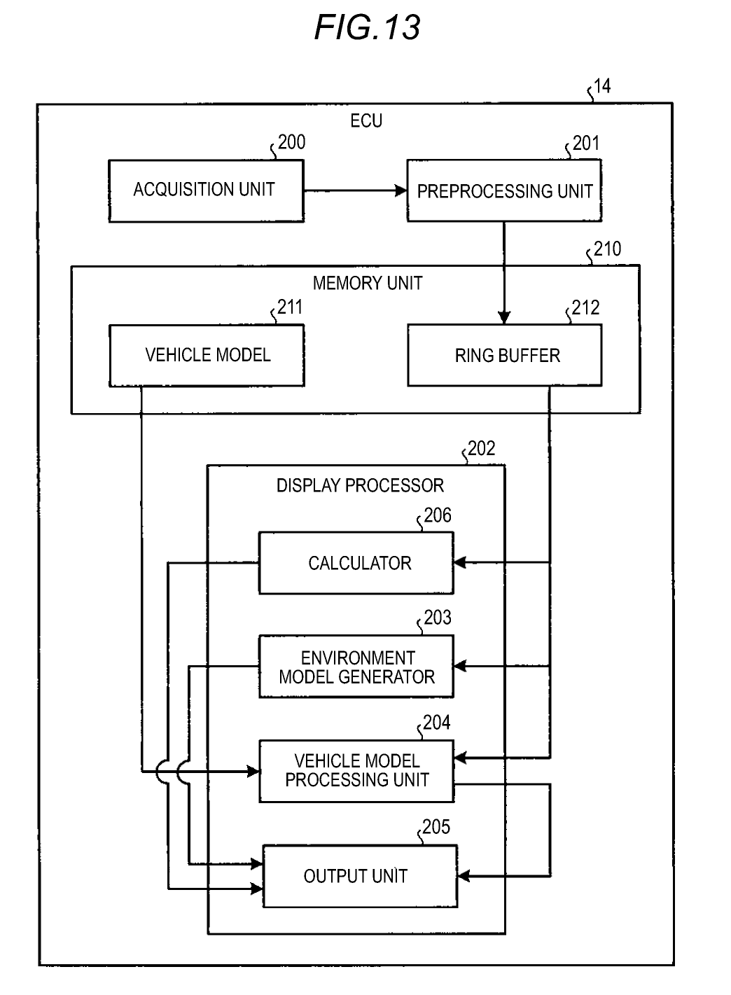

FIG. 13 is a block diagram illustrating a functional configuration of an ECU 14 as the periphery monitoring device according to the second embodiment. The periphery monitoring device according to the second embodiment is different from the periphery monitoring device according to the first embodiment in that a calculator 206 is added to the display processor 202. Here, parts different from those in the first embodiment will be mainly described, and redundant descriptions will be omitted.

In the second embodiment, the laser range scanner 15 serves as a measuring unit that measures the position of an obstacle. As the measuring unit for measuring the position of the obstacle, other devices, such as an ultrasonic sonar, a stereo camera or the like, may be employed in place of the laser range scanner 15.

The calculator 206 acquires the position of the obstacle present in a movable range of the door 2d based on topographical data obtained from the measurement result of the laser range scanner 15. The obstacle refers to an obstacle that obstructs opening/closing of the door 2d. The calculator 206 calculates a movable range limited by the obstacle based on the position of the obstacle. The movable range limited by the obstacle refers to a range in which the door 2d may be opened without colliding with the obstacle.

The output unit 205 displays a display object indicating the movable range limited by the obstacle on the display screen 8 so that the movable range limited by the obstacle may be recognized through the display screen 8.

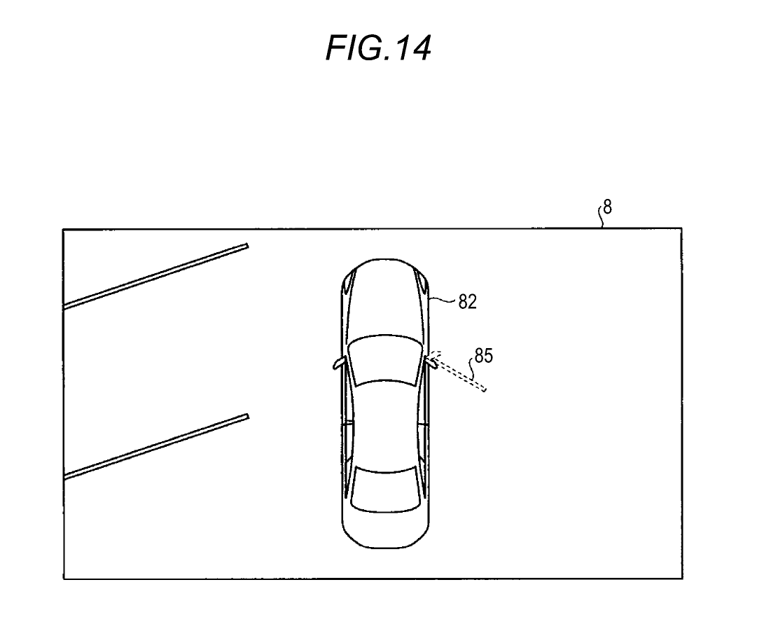

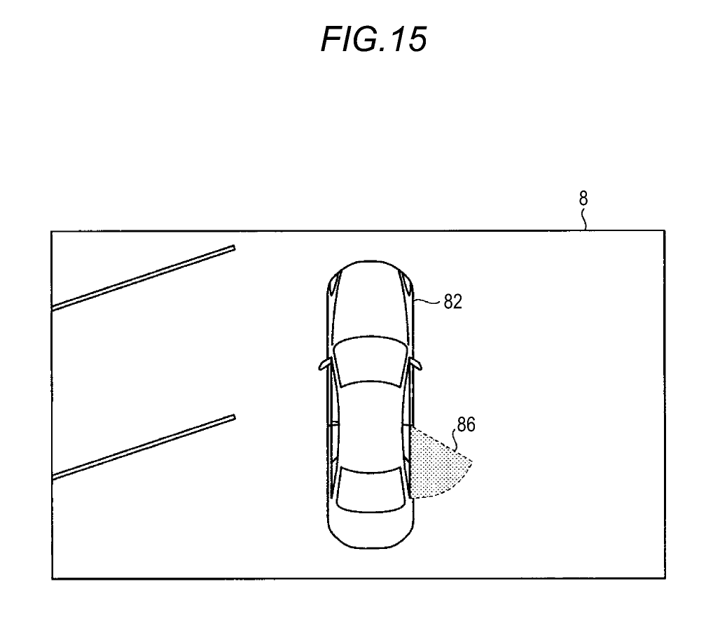

FIGS. 14 and 15 are views illustrating display examples of the display screen 8 according to the second embodiment. In the example of FIG. 14, the position at which the door 2d is opened to the maximum within the movable range limited by the obstacle is displayed by a display object 85 representing the model of the door 2d in dashed lines. In the example of FIG. 15, the movable range limited by the obstacle is displayed by a display object 86 in a hatched fan shape. Examples of a display object indicating the movable range limited by the obstacle are not limited thereto.

As described above, according to the second embodiment, the periphery monitoring device further acquires the position of the obstacle and calculates the movable range of the door 2d limited by the obstacle. The periphery monitoring device displays the movable range of the door 2d limited by the obstacle on the display screen 8 through the display object. This allows the user to open the door 2d at ease without putting his head out of the window to check the outside.

Although embodiments disclosed here have been exemplified, these embodiments and modifications are exemplary only, but are not intended to limit the scope of the disclosure. The embodiments and modifications may be implemented in other various forms, and various omissions, substitutions, combinations, and changes may be made without departing from the gist of the disclosure. Also, the configurations or shapes of the respective embodiments and modifications may be partially replaced in implementation.

A periphery monitoring device according to an aspect of this disclosure includes, for example, an acquisition unit that acquires an image indicating a peripheral environment of a vehicle and information corresponding to a state of the vehicle, in which the image is captured by an imaging device that is provided in the vehicle; a memory that stores a vehicle model that indicates a three-dimensional shape of the vehicle; a processing unit that processes the vehicle model based on the information; and an output unit that superimposes the vehicle model processed by the processing unit on a position within the image indicating the peripheral environment corresponding to a position within the peripheral environment where the vehicle is present, and displays the image indicating the peripheral environment and having the vehicle model superimposed thereon on a display screen that is provided in a vehicle compartment of the vehicle. The periphery monitoring device reflects the state of the vehicle on the image of the vehicle displayed on the display screen in real time, and thus may display the state of the vehicle in an objectively and easily understandable manner.

In the periphery monitoring device, for example, the information may be information that indicates an extension/contraction amount of a suspension configured to perform positioning of a wheel according to extension/contraction, and the processing unit may change a distance between a model of the wheel and a model of a vehicle body included in the vehicle model, according to the extension/contraction amount. Accordingly, the user may grasp the state of the wheel according to the peripheral environment while staying in the vehicle compartment.

In the periphery monitoring device, for example, the acquisition unit may further acquire a three-dimensional shape of a road surface measured by a measuring unit provided in the vehicle, the periphery monitoring device may further include a generator that generates an environment model in which the image indicating the peripheral environment is projected on the three-dimensional shape of the road surface acquired by the acquisition unit, and the output unit may display the environment model generated by the generator on the display screen. Accordingly, the user may recognize whether the wheel is in contact with ground through the display screen.

In the periphery monitoring device, for example, the information may be information that indicates whether a lighting device provided in the vehicle is turned ON or turned OFF, and the processing unit may change a color of a model of the lighting device included in the vehicle model according to whether the lighting device is turned ON or turned OFF. Accordingly, the user may check the turning ON/OFF of the lighting device through the display screen.

In the periphery monitoring device, for example, the information may be information that indicates whether a door provided in the vehicle is opened or closed, and the processing unit may change an angle between a model of the door and a model of a vehicle body included in the vehicle model, according to whether the door is opened or closed. Accordingly, the user may check whether the door is opened or closed through the display screen.

In the periphery monitoring device, for example, the acquisition unit may further acquire a location of an obstacle which is measured by a measuring unit provided in the vehicle, the periphery monitoring device may further include a calculator that calculates a movable range of the door which is limited by the obstacle, and the output unit may further display a display object that indicates the movable range calculated by the calculator on the display screen. Accordingly, the user may open the door at ease without putting his head out of the window to check the outside.

In the periphery monitoring device, for example, the information may be information that indicates an angle between a door provided in the vehicle and a vehicle body side surface portion of the vehicle, and the processing unit may change an angle between a model of the door and a model of the vehicle body side surface portion included in the vehicle model, according to the angle between the door provided in the vehicle and the vehicle body side surface portion of the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A periphery monitoring device comprising:
an acquisition unit that acquires an image indicating a peripheral environment of a vehicle and information corresponding to a state of the vehicle, the image being captured by an imaging device that is provided in the vehicle;
a memory that stores a vehicle model that indicates a three-dimensional shape of the vehicle;
a processing unit that processes the vehicle model based on the information; and
an output unit that superimposes the vehicle model processed by the processing unit on a position within the image indicating the peripheral environment corresponding to a position within the peripheral environment where the vehicle is present, and displays the image indicating the peripheral environment and having the vehicle model superimposed thereon on a display screen that is provided in a vehicle compartment of the vehicle.

2. The periphery monitoring device according to claim 1,
wherein the information is information that indicates an extension/contraction amount of a suspension configured to perform positioning of a wheel according to extension/contraction, and
the processing unit changes a distance between a model of the wheel and a model of a vehicle body included in the vehicle model, according to the extension/contraction amount.

3. The periphery monitoring device according to claim 2,
wherein the acquisition unit further acquires a three-dimensional shape of a road surface measured by a measuring unit provided in the vehicle,
the periphery monitoring device further comprises a generator that generates an environment model in which the image indicating the peripheral environment is projected on the three-dimensional shape of the road surface acquired by the acquisition unit, and
the output unit displays the environment model generated by the generator on the display screen.

4. The periphery monitoring device according to claim 1,
wherein the information is information that indicates whether a lighting device provided in the vehicle is turned ON or turned OFF, and
the processing unit changes a color of a model of the lighting device included in the vehicle model according to whether the lighting device is turned ON or turned OFF.

5. The periphery monitoring device according to claim 1,
wherein the information is information that indicates whether a door provided in the vehicle is opened or closed, and
the processing unit changes an angle between a model of the door and a model of a vehicle body included in the vehicle model, according to whether the door is opened or closed.

6. The periphery monitoring device according to claim 5,
wherein the acquisition unit further acquires a location of an obstacle which is measured by a measuring unit provided in the vehicle,
the periphery monitoring device further comprises a calculator that calculates a movable range of the door which is limited by the obstacle, and
the output unit further displays a display object that indicates the movable range calculated by the calculator on the display screen.

7. The periphery monitoring device according to claim 1,
wherein the information is information that indicates an angle between a door provided in the vehicle and a vehicle body side surface portion of the vehicle, and
the processing unit changes an angle between a model of the door and a model of the vehicle body side surface portion included in the vehicle model, according to the angle between the door provided in the vehicle and the vehicle body side surface portion of the vehicle.
